(19) United States
(12) Patent Application Publication
(10) Pub. No.: US 2010/0161219 A1
(43) Pub. Date: Jun. 24, 2010

(54) UPDATE SYSTEM FOR ELECTRONIC MAPS AND METHOD THEREOF

(75) Inventor: Wei-Yi Lo, Kuei San Hsiang (TW)

Correspondence Address: Wang Law Firm, Inc., 4989 Peachtree Parkway,, Suite 200, Norcross, GA, 30092, US

(73) Assignee: MITAC INTERNATIONAL CORP, Kuei San Hsiang (TW)

(21) Appl. No.: 12/552,589

(22) Filed: Sep. 2, 2009

(30) Foreign Application Priority Data
Dec. 23, 2008 (TW) 097150310

(51) Int. Cl. G01C 21/32; G01C 21/00

(52) U.S. Cl. 701/208; 701/213

(57) ABSTRACT

The present invention discloses an update system for electronic maps and a method thereof. The update system for electronic maps and method thereof comprises a database which stores an electronic map composed of a plurality of block maps, a positioning module which receives a position signal, a navigation module which provides a drive path leading to a destination according to the position signal in conjunction with the electronic map, and an update module which marks the block maps the drive path passes by and updates the marked block maps based on the drive path and the position signal.

### BACKGROUND OF THE INVENTION

1. Field of the Invention

The present invention relates to an update system for updating electronic maps and a method thereof, and in particular to an update system for automatically updating electronic maps in accordance with a path hack and a method thereof.

2. Description of Related Art

The use of Global Positioning System (GPS) in early days was for military purposes; later it is comprehensively utilized in fields of measurement and plotting such as geodetic surveying, engineering measurement, conveyance navigation and surveillance. In recent years, as private cars gradually prevail, the road positioning device with the GPS becomes a technology generally applied in daily lives for common people. Since portable electronic devices, such as mobile phones, personal digital assistants (PDAs) etc., have become more widely employed than vehicles nowadays, many manufacturers of portable electronic devices are now preparing to release, or have released, portable electronic devices integrated with a GPS receiver offering a positioning function.

The positioning function is implemented by means of utilizing the GPS in which a position coordinate with the road data (i.e. the electronic map) archived in a road database is compared, so as to compute the road and actual position where the portable electronic device is currently located. In the aforementioned positioning navigation function, the key to exact positioning is by providing electronic maps with high precision, high accuracy and most up-to-date information.

Currently available update methods for electronic maps are usually accomplished in a way that a user first downloads some graphic information through networks, and then updates the maps held in navigation devices via a transmission interface. Specifically, all graphic information are downloaded at one time, e.g. to download a file for updating the map of Taiwan or more precisely updating the map of Taipei city.

Regardless, the user always needs to perform on-line download and update larger graphic information, even though most of the downloaded graphic information might be used or needed by the user. Additionally, the more the amount of graphic information to be updated, the longer the download time.

### SUMMARY OF THE INVENTION

In view of the issues illustrated as above, one objective of the present invention is to provide an update system for electronic maps and a method thereof, so as to effectively solve the problem found in the prior art that the user has to particularly connect online to download a large amount of unused or unnecessary graphic information for system update operations.

According to the objective of the present invention, an update system for electronic maps is herein proposed, which comprises a database, a positioning module, a navigation module and an update module. Wherein, the database stores an electronic map which comprises a plurality of block maps. The positioning module may be a Global Positioning System (GPS) module and could be used to receive a position signal indicating where the update system is currently located. The navigation module provides a best drive path leading to a destination according to the received position signal as a start point in conjunction with the electronic map stored in the database. The update module can mark the block maps the drive path passes by along the way and update the marked block maps based on the drive path in conjunction with the motion of the position signal. Herein each block map may be further composed of a plurality of layer data, such as meteorological information layer, traffic information layer and road information layer and so on.

Herein the navigation module may further comprise a selection module which allows the user to choose whether to store the planned drive path into the database, or to select the required drive path in case one or more sets of drive paths are stored in the database.

Additionally, the update module may further comprise an inquiry module and a record module. The inquiry module can actively send an inquiry signal to a remote server for checking the existence of the update information according to the block maps that the drive path passes by. Each block map has a corresponding block number and a version number, and the inquiry signal comprises the corresponding block numbers and version numbers of all the marked block maps, thus facilitating the remote server to check the map update information in accordance with such received block numbers and version numbers. The record module can record the number of marks for each block map and set a threshold, such that the update module can automatically update the block map having the number of marks greater than the threshold, in order to keep the frequently used path information in a most up-to-date state.

An update method for electronic maps according to the present invention is also further proposed. The update method comprises the following steps: receiving a position signal; acquiring an electronic map which comprises a plurality of block maps; providing a drive path leading to a destination according to the position signal in conjunction with the electronic map; marking the block maps the drive path passes by and updating each of all marked block maps based on the drive path and the position signal.

However, each user has his or her most frequently used paths, such as daily routes heading for offices, schools, markets and so on. Consequently, the update method for electronic maps according to the present invention may further comprise the following steps: recording the number of marks for each block map and setting a threshold, such that the update module is allowed to automatically update the block maps whose numbers of marks are greater than the threshold.

In summary, the update system for updating electronic maps and method thereof according to the present invention provides one or more of the following advantages:

(1) Since the electronic map is divided into a plurality of minor map blocks, it is possible to focus simply on updating such relevant minor block maps in updating the electronic map.

(2) The user can be assured that the acquired road information is up-to-date because the map is update in accordance with the drive path or frequently used path.

### BRIEF DESCRIPTION OF THE DRAWINGS

FIG. 1 shows a diagram of the update system for electronic maps in accordance with an embodiment of the present invention;

FIG. 2 shows a diagram of electronic map division of the update system for electronic maps in accordance with the present invention;

FIG. 3 show a diagram of an update approach for the update system for electronic maps in accordance with the present invention;

FIG. 4 shows a diagram of the update system for electronic maps in accordance with another embodiment of the present invention;

FIG. 5 shows a stepwise flowchart of a first update method for electronic maps in accordance with the present invention; and

FIG. 6 shows a stepwise flowchart of a second update method for electronic maps in accordance with the present invention.

### DETAILED DESCRIPTION OF THE PREFERRED EMBODIMENTS

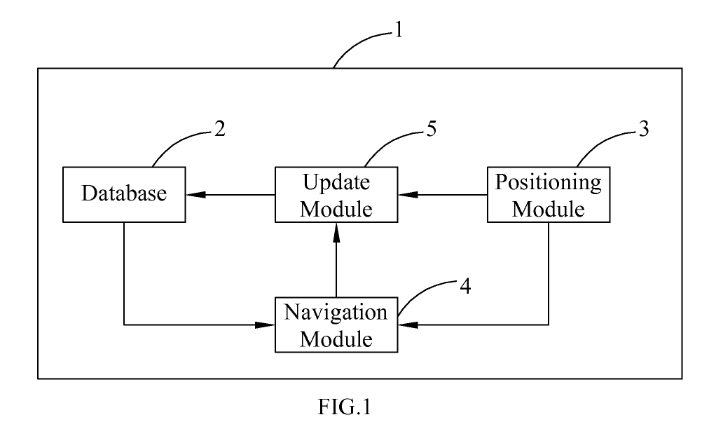

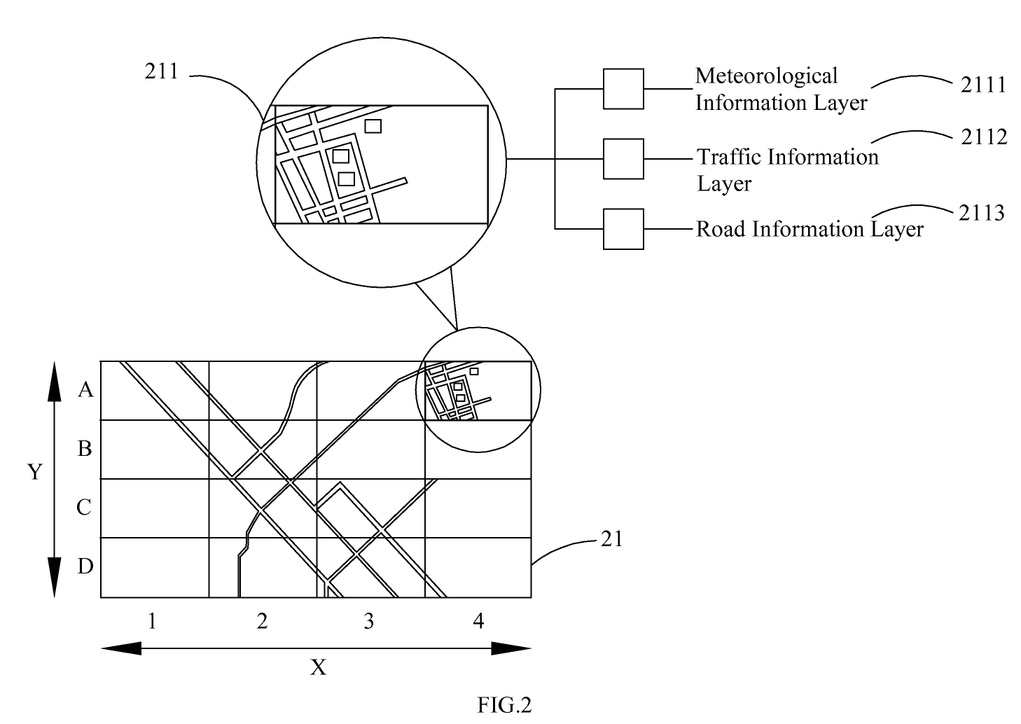

Referring to FIG. 1, a diagram of the update system for electronic maps in accordance with an embodiment of the present invention is shown. In the Figure, the update system 1 comprises a database 2, a positioning module 3, a navigation module 4 and an update module 5. The database 2 stores an electronic map comprising a plurality of block maps. Referring also to FIG. 2, the electronic map 21 depicted therein is a regional road map, and due to extensive coverage thereof, the amount of data in updating the map may be enormous, so the electronic map 21 is divided along the horizontal axis X and vertical axis Y into an equally numbered plurality of square block maps 211, with each block map 211 having a corresponding block number. It goes without saying that, in addition to square, the shape of such block maps can be of other geometry created by using different division approaches, such as triangle, rhomb etc. Each block map 211 may further comprise a plurality of layer data, for example, meteorological information layer 2111, traffic information layer 2112 and road information layer 2113.

The positioning module 3 may be a Global Positioning System (GPS), and as the system operates, the positioning module 3 can obtain to the current position of the user and transfer the corresponding position signal to the navigation module 4.

The navigation module 4 plans the best drive path leading to a destination based on the position signal in conjunction with the electronic map, in which the origin and the destination can be entered by the user, or alternatively the positioning module 3 can use the current position signal of the user as the start point of the drive path so as to prevent inconvenience of data input.

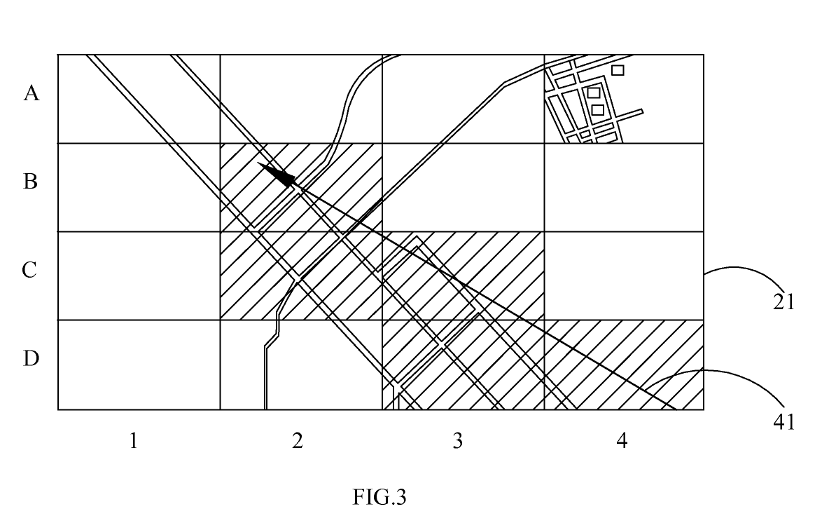

The update module 5 may initially mark the block maps that the drive path passes by, and then update each of the block maps passed by along the drive path from the start point in a fashion of dominos series according to the drive path and the position signal. Referring to FIG. 3, the update module 5 locates the involved block maps according to the track of the drive path 41, which are sequentially D4, D3, C3, C2 and B2, i.e. the block maps to be updated, as shown in the Figure. Afterward, it updates each of the block maps along the drive path 41. Since the electronic map 21 is divided into a plurality of minor block maps and each of the block maps is composed of a plurality of layer data such as meteorological information layer, traffic information layer and road information layer, the user is hence allowed to acquire in real-time and efficiently the information along the path based on the drive path, which information being required to be appreciated only before departure for the destination or in the mid-way toward it, such as meteorological information like heavy rainfall or foggy sections, traffic information like jammed routes, road information e.g. roads closed due to highway or bridge constructions. Accordingly, it is possible to significantly shorten the time required for update, and enable provisions of information the user most imminently needs.

Besides, the update module 5 may receive new block maps through wireless transmissions, in which the wireless transmissions can be implemented by means of technologies such as Short Message Service (SMS) and Multimedia Messaging Service (MMS) in General Packet Radio Service (GPRS) or Global System for Mobile Communications (GSM).

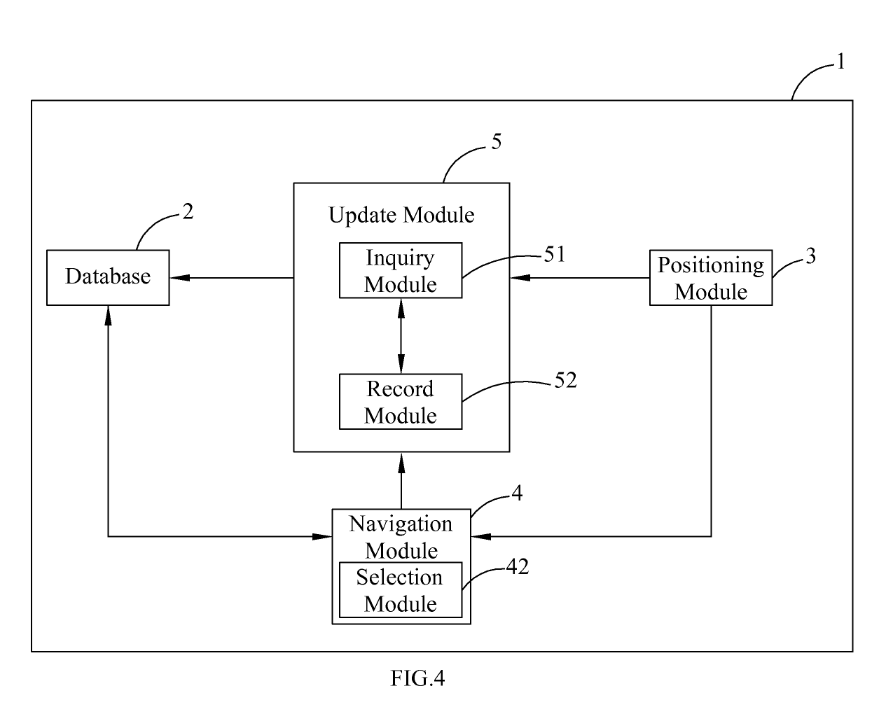

Referring to FIG. 4, a diagram of the update system for electronic maps in accordance with another embodiment of the present invention is shown. The differences between the present embodiment and the one illustrated in FIG. 1 lie in that the navigation module 4 in the update system 1 may further comprise a selection module 42, and the update module 5 may further comprise an inquiry module 51 and a record module 52.

The selection module 42 in the navigation module 4 allows the user to choose whether to store the planned drive path into the database 2, or to select the required drive path in case one or more sets of drive paths are stored in the database 2.

The inquiry module 51 in the update module 5 actively sends an inquiry signal to a remote server enabling block map download to check for the existence of any updated block map information in accordance with the block maps that the drive path passes by, and in case that more recent block map information exist in the above-mentioned remote server, the new block maps will then be returned to the update module 5. The inquiry signal issued from the inquiry module 51 can be implemented wirelessly as well. Herein the block map may also comprise a block number and a version number, and upon inquiry for existence of any updated block maps, the inquiry signal can transfer the block number and the version number allowing the remote server to determine whether it should return the updated maps, if any, simply by performing block map checks based on the received block number and then comparing the version numbers to see if any inconsistency exists therebetween, e.g. higher version number indicating newer version.

The record module 52 records the number of marks for each block map in the electronic map, sets a threshold, and increments the number of marks by 1 for each block map passed by along the drive path.

Since every user has his/her own more frequently used paths, e.g. the route heading for office, school or market, in daily lives, the inquiry module 51 may automatically send an inquiry signal regularly for a duration of time or upon initiation of the update system 1 in accordance with the number of marks created by the record module 52, so as to inquire the remote server for the block maps whose numbers of marks are greater than the threshold, thereby updating such block maps having numbers of marks greater than the threshold, and allowing to keep the route information frequently utilized by the user to be up-to-date without additional manual operations and time for update.

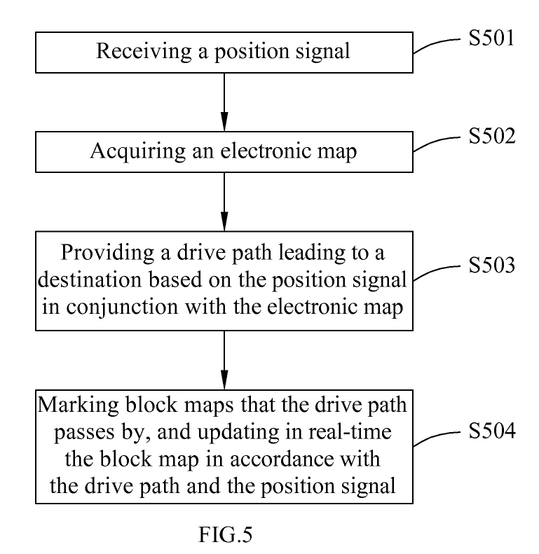

Referring to FIG. 5, a stepwise flowchart of a first update method for electronic maps in accordance with the present invention is shown, in which the electronic map is updated based on the block maps the drive path passes by. The update method illustrated herein comprises die following steps:

STEP S501: receiving a position signal, thereby acquiring the position information indicating the user's current position by means of GPS;

STEP S502: acquiring an electronic map composed of a plurality of block maps;

STEP S503: providing a drive path leading to a destination according to the position signal in conjunction with the electronic map;

STEP S504: marking the block maps that the drive path passes by, and updating in real-time the block maps based on the drive path and the position signal.

The user is allowed to enter the intended destination upon initiation of the update system according to the above steps, and afterward receive the information provided in STEP S501 and STEP S502. In STEP S503, a drive path can be planned based on the information provided in STEP S501 and STEP S502, in which each block map has a corresponding block number. Finally, the block map data is updated one by one through the block numbers of the block maps passed by along the drive path provided in STEP S503, as marked in STEP S504, in accordance with the drive path and the position signal.

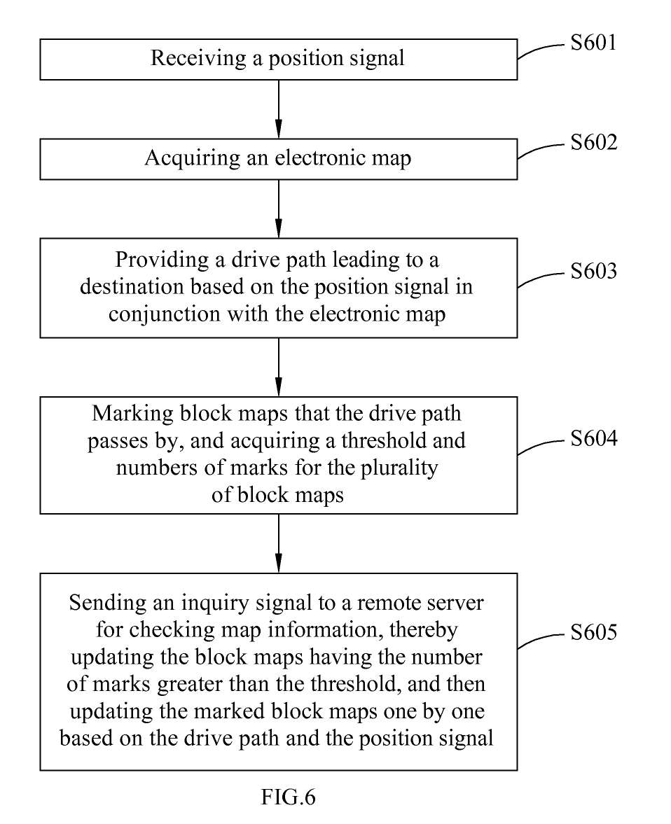

Referring to FIG. 6, a stepwise flowchart for a second update method for electronic maps according to the present invention is shown. The present update method comprises the following steps:

STEP S601: receiving a position signal, thereby acquiring the position information indicating the user's current position by means of GPS;

STEP S602: acquiring an electronic map from the database, which electronic map being composed of a plurality of block maps;

STEP S603: providing a drive path leading to a destination according to the position signal in conjunction with the electronic map;

STEP S604: marking the block maps that the drive path passes by, and acquiring a threshold and numbers of marks for such plurality of block maps;

STEP S605: sending an inquiry signal to a remote server for map information, so as to update the block maps having numbers of marks greater than the threshold, and then updating the marked block maps one by one based on the drive path and the position signal.

The user is allowed to enter the intended destination upon initiation of the update system according to the above steps, and afterward receive the information provided in STEP S601 and STEP S602. In STEP S602, each block map further comprises a block number and a version number. In STEP S603, a drive path can be planned based on the information provided in STEP S601 and STEP S602, in which it is possible to select a previously planned drive path from the database. Through STEP S604, the method marks the block numbers of the block maps passed by along the drive path provided in STEP S603, records the number of marks for each of the block maps all along the path, and then sets a threshold. Finally, in STEP S605, in case the number of marks for any block map becomes greater than the threshold, an inquiry signal will be sent to the remote server, in which such an inquiry signal comprises the corresponding block numbers and version numbers of the block maps whose numbers of marks are greater than tie threshold. Furthermore, the remote server determines whether it is required to return any updated block maps for updating the block maps based on the received block numbers and by comparing if any difference exists in the version numbers, e.g. higher version number indicating newer version. Following this, the block map data is updated one by one based on the drive path and the block map where the position signal is located.

In summary, the update system for updating electronic maps and method thereof according to the present invention provides effects which allow the update system to update the electronic map based on the block maps that a planned drive path or the frequently used path, passes by, such that overly long duration of time required for downloading massive graphic information of no necessity can be thereby saved, and meanwhile the electronic map utilized in the previously planned drive path or the frequently used path can be maintained in the most up-to-date fashion.

The aforementioned descriptions are exemplary rather than being limiting. All effectively equivalent modifications or changes made to the embodiments illustrated as above without departing from the spirit and scope of the present invention are to be deemed as being encompassed by the claims set forth hereunder.

What is claimed is:

1. An update system for electronic maps, comprising:
a database storing an electronic map comprising a plurality of block maps;
a positioning module receiving a position signal;
a navigation module providing a drive path leading to a destination according to the position signal in conjunction with the electronic map; and
an update module marking the block maps the drive path passes by and updating the marked block maps based on the drive path and the position signal.

2. The update system for electronic maps according to claim 1, wherein each of the plurality of block maps further comprises a plurality of layer data.

3. The update system for electronic maps according to claim 2, wherein the plurality of layer data comprise one of meteorological information, traffic information and road information.

4. The update system for electronic maps according to claim 1, wherein the navigation module is further able to store the drive path into the database.

5. The update system for electronic maps according to claim 4, wherein the navigation module further comprises a selection module which allows a user to select the drive path when one or more sets of drive paths are stored in the database.

6. The update system for electronic maps according to claim 1, wherein the update module further comprises an inquiry module which sends an inquiry signal to a remote server for checking existence of any update information.

7. The update system for electronic maps according to claim 6, wherein each of the plurality of block maps has a block number and a version number.

8. The update system for electronic maps according to claim 7, wherein the inquiry signal comprises the corresponding block number and version number of the marked block map, so as to allow the remote server to inquire the existence of any update information based on the block number and the version number.

9. The update system for electronic maps according to claim 1, wherein the update module further comprises a record module which records a threshold and the number of marks for each of the plurality of block maps, thereby allowing the update module to update the block maps whose numbers of marks are greater than the threshold.

10. The update system for electronic maps according to claim 1, wherein the positioning module comprises a Global Positioning System (GPS) module.

11. An update method for electronic maps, comprising the following steps:
receiving a position signal;
acquiring an electronic map from an database, the electronic map comprising a plurality of block maps;
providing a drive path leading to a destination according to the position signal in conjunction with the electronic map;
marking the block maps the drive path passes by and updating the marked block maps based on the drive path and the position signal.

12. The update method for electronic maps according to claim 11, wherein each of the plurality of block maps further comprises a plurality of layer data.

13. The update method for electronic maps according to claim 12, wherein the plurality of layer data comprise one of meteorological information, traffic information and road information.

14. The update method for electronic maps according to claim 11, wherein the drive path is further able to be stored into the database.

15. The update method for electronic maps according to claim 14, further comprising a selection step which allows a user to select the drive path when one or more sets of drive paths are stored in the database.

16. The update method for electronic maps according to claim 11, further comprising the following step:
sending an inquiry signal to a remote server for checking existence of any update information.

17. The update method for electronic maps according to claim 16, wherein each of the plurality of block maps has a block number and a version number.

18. The update method for electronic maps according to claim 17, wherein the inquiry signal comprises the corresponding block number and version number of the marked block map, so as to allow the remote server to inquire the existence of any update information based on the block number and the version number.

19. The update method for electronic maps according to claim 11, further comprising a record step which records a threshold and the number of marks for each of the plurality of block maps, thereby allowing the update module to update the block maps whose numbers of marks are greater than the threshold.

20. The update method for electronic maps according to claim 11, wherein the positioning signal is provided by a Global Positioning System (GPS) module.
